(19) United States
(12) Patent Application Publication
(10) Pub. No.: US 2015/0017524 A1
(43) Pub. Date: Jan. 15, 2015

(54) ELECTRODE ACTIVE MATERIAL FOR RECHARGEABLE LITHIUM BATTERY, METHOD FOR PREPARING THE SAME, ELECTRODE INCLUDING THE SAME, AND RECHARGEABLE LITHIUM BATTERY INCLUDING THE ELECTRODE

(71) Applicant: POSCO CHEMTECH CO., LTD., Pohang-si (KR)

(72) Inventors: Mi Ryeong Lee, Sejong (KR); Heon Young Lee, Cheonan-si (KR); Kyoung Muk Lee, Sejong (KR); Hyun Ki Choi, Cheongwon-gun (KR)

(73) Assignee: POSCO CHEMTECH CO., LTD., Pohang-si (KR)

(21) Appl. No.: 14/065,628

(22) Filed: Oct. 29, 2013

(30) Foreign Application Priority Data
Jul. 15, 2013 (KR) 10-2013-0083008

(51) Int. Cl. H01M 4/36; H01M 4/62; H01M 10/052; H01M 4/1393; H01M 4/133; H01M 4/587; H01M 4/04

(52) U.S. Cl. CPC H01M 4/366; H01M 4/587; H01M 4/62; H01M 4/0402; H01M 4/1393; H01M 4/133; H01M 10/052
USPC 429/212; 429/231.8; 427/113

(57) ABSTRACT

Disclosed is an electrode active material for a rechargeable lithium battery, including: a core part including a carbon-based active material; and a coating layer disposed on a surface of the core portion to include a ceramic, wherein the surface of the core part is subjected to coating with a low crystalline carbon material, a method for preparing the same, an electrode including the same, and a rechargeable lithium battery including the electrode.

### CROSS-REFERENCE TO RELATED APPLICATION

This application claims priority to and the benefit of Korean Patent Application No. 10-2013-0083008 filed in the Korean Intellectual Property Office on Jul. 15, 2013, the entire contents of which are incorporated herein by reference.

### BACKGROUND OF THE INVENTION

(a) Field of the Invention

The following disclosure relates to an electrode active material for a rechargeable lithium battery, a method for preparing the same, an electrode including the same, and a rechargeable lithium battery including the electrode.

(b) Description of the Related Art

A rechargeable lithium battery has recently become prominent as a power supply for portable small electronic devices. The rechargeable lithium battery has a discharge voltage of two times higher than an existing battery using an aqueous alkaline solution by using an organic electrolyte solution. As a result, the rechargeable lithium battery provides higher energy density than the existing battery.

As a cathode active material for the rechargeable lithium battery, an oxide formed of lithium having a structure in which intercalation of lithium ions is possible, such as LiCoO₂, LiMn₂O₄, LiNi₁₋ₓCoₓO₂ (0<x<1), or the like and a transition metal is mainly used.

An as anode active material, various types of carbon materials including artificial graphite, natural graphite, and hard carbon capable of intercalating/deintercalating lithium ions have been used. The graphite among the carbon materials has a discharge voltage of −0.2 V, which is a lower discharge voltage than that of lithium. Therefore, the rechargeable lithium battery using the graphite has a high discharge voltage of 3.6 V, thereby providing good energy density. In addition, the graphite has excellent reversibility to thereby improve cycle life of the rechargeable lithium battery. Thus, the graphite has been widely used.

However, when the graphite is used, a swelling phenomenon occurs involving the volume expansion and shrinkage by about 10% at the time of intercalation and deintercalation reactions of lithium ions. Thus, a solid-electrolyte interface (SEI) film formed on a surface of an anode material is destroyed, and a new SEI film is formed to thereby increase the thickness of the SEI film. As a result, the cycle life characteristic of the battery is deteriorated, a spatial limitation is present due to the volume expansion, and electrolyte may leak due to mechanical stress. Therefore, the performance of the battery may be deteriorated.

Particularly, with a middle or large-sized battery, which is a module pack in which several cells are joined together, it is required to secure a space because of the swelling of the battery, such that the middle or large-sized battery has a spatial limitation and all cells are affected due to volume expansion of one cell, and thus the swelling problem should be overcome. As a result, the cycle life of the battery may be shortened and safety of the battery may be affected.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an electrode active material for a rechargeable lithium battery capable of improving long-term reliability and resistance by suppressing a swelling phenomenon, and a rechargeable lithium battery capable of having improved electrochemical characteristics and safety.

The present invention also provides a method for preparing an electrode active material for a rechargeable lithium battery.

An exemplary embodiment of the present invention provides an electrode active material for a rechargeable lithium battery, including: a core part including a carbon-based active material; and a coating layer disposed on a surface of the core portion to include a ceramic, wherein the surface of the core part is subjected to coating with a low crystalline carbon material.

The carbon-based active material may be natural graphite, artificial graphite, soft carbon, hard carbon, or a combination thereof.

The low crystalline carbon material may be petroleum-based pitch, coal-based pitch, mesophase pitch, low molecular heavy oil, polyvinyl alcohol (PVA), polyvinyl chloride (PVC), sucrose, phenol resin, furan resin, furfuryl alcohol, polyacrylonitrile, cellulose, styrene, polyimide, epoxy resin, glucose, or a combination thereof.

The ceramic may be an oxide generated from a metal oxide, a non-metal oxide, a composite metal oxide, a rare-earth oxide, a metal halide, a ceramic precursor, or combination thereof.

The ceramic precursor may be zirconia, aluminum, polycarbosilane, polysiloxane, polysilazane, or a combination thereof.

The ceramic may be SiO₂, Al₂O₃, Li₄Ti₅O₁₂, TiO₂, CeO₂, ZrO₂, BaTiO₃, Y₂O₃, MgO, CuO, ZnO, AlPO₄, AlF, Si₃N₄, AlN, TiN, WC, SiC, TiC, MoSi₂, Fe₂O₃, GeO₂, Li₂O, MnO, NiO, zeolite, or a combination thereof.

An average particle size of the carbon-based active material may be 5 to 30 μm.

An average particle size of the ceramic may be 10 to 1000 nm.

Another embodiment of the present invention provides a method for preparing an electrode active material for a rechargeable lithium battery, including mixing a carbon-based active material of which the surface is subjected to coating with a low crystalline carbon material and a ceramic by using a mechanical mixing method.

The mechanical mixing method may be performed between 500 and 7000 rpm.

A content of the ceramic may be 0.1 to 10 parts by weight based on 100 parts by weight of the carbon-based active material, wherein the surface is subjected to coating with the low crystalline carbon material.

Yet another exemplary embodiment of the present invention provides a rechargeable lithium battery including an electrode including the electrode active material and an electrolyte.

Specific matters of other exemplary embodiments of the present invention will be included in the detailed description.

According to an exemplary embodiment of the present invention, the electrode active material for the rechargeable lithium battery capable of suppressing the swelling phenomenon by performing the ceramic coating on the surface of the active material is provided, such that a rechargeable lithium battery in which electrochemical and safety characteristics are improved can be implemented.

### BRIEF DESCRIPTION OF THE DRAWINGS

FIG. 1 is an exploded perspective view of a rechargeable lithium battery according to an exemplary embodiment of the present invention.

FIG. 2 is a scanning electron microscope (SEM) photograph showing a surface state of an anode active material according to an exemplary embodiment of the present invention.

FIG. 3 is a scanning electron microscope (SEM) photograph showing a surface state of an anode active material according to Comparative Example 1.

FIG. 4 is a graph showing results of spring back for a rechargeable lithium battery evaluated at 60° C. according to an exemplary embodiment of the present invention.

FIG. 5 is a graph showing a degree of swelling of a rechargeable lithium battery according to an exemplary embodiment of the present invention.

FIG. 6 is a graph showing impedance (resistance) of a rechargeable lithium battery according to an exemplary embodiment of the present invention.

### DETAILED DESCRIPTION OF THE EMBODIMENTS

Hereinafter, embodiments of the present invention will be described in detail. However, the embodiments are described for illustrative purpose, and the present invention is not limited thereto. Therefore, the present invention will be defined by the scope of the appended claims to be described below.

An electrode active material for a rechargeable lithium battery according to the exemplary embodiment of the present invention includes a core part including a carbon-based active material, and a coating layer including a ceramic disposed on a surface of the core portion, wherein the surface of the core part may be subjected to coating with a low crystalline carbon material.

Generally, as an anode active material for the rechargeable lithium battery, a crystalline-based carbon material such as artificial graphite or natural graphite in which intercalation/deintercalation of lithium ions is possible has been used.

In detail, since the graphite has a discharge voltage of 0.2 V, it has a lower discharge voltage than lithium, and in the case in which the graphite is used as the active material, the rechargeable lithium battery has a high discharge voltage of 3.6 V, thereby providing good energy density. In addition, the graphite has excellent reversibility to thereby improve the cycle life of the rechargeable lithium battery. Thus, the graphite has been widely used.

In a case of the anode active material for the rechargeable lithium battery, a graphite series active material having crystallinity such as the natural graphite and the artificial graphite has been mainly used. However, in a case of the graphite series active material, intercalation and deintercalation of the lithium ions are generated between graphite layers having crystallinity at the time of charging/discharging, and causes the volume expansion and shrinkage of about 10%. Thus, a solid-electrolyte interface (SEI) film formed on a surface of the anode material is destroyed, and a new SEI film is formed to thereby increase the thickness of the SEI film. As a result, the cycle life characteristic of the battery is deteriorated, a spatial limitation is present due to the volume expansion, and electrolyte may leak due to mechanical stress.

Particularly, with a middle or large-sized battery, which is a module pack in which several cells are joined together, it is required to secure a space because of the swelling of the battery, such that the middle or large-sized battery has a spatial limitation and all cells are affected due to volume expansion of one cell, and thus the swelling problem should be overcome. As a result, the cycle life of the battery may be shortened and safety of the battery may be affected.

In addition, in a case of the cathode active material, a metal material such as Mn, Fe, Ni, Co, or the like is dissolved to cause deterioration in high temperature performance, such that the performance of the battery may be deteriorated. In order to compensate for this problem, the development of a high-safety anode active material has been demanded.

The electrode active material according to the exemplary embodiment of the present invention suppresses the volume expansion and shrinkage due to the intercalation and deintercalation of the lithium ions at the time of charging/discharging by coating the surface of the core part including the carbon-based active material with the ceramic to secure long-term reliability. Further, the electrode active material reduces the deterioration in the battery performance generated due to the problem that the metal material such as Mn, Fe, Ni, Co, or the like is dissolved to cause the deterioration in high temperature performance of the cathode material.

Particularly, the ceramic may be uniformly coated without a coagulation phenomenon on the edge surface of the carbon-based active material by using the carbon-based active material where the surface is subjected to coating with the low crystalline carbon material.

In the case in which the electrode active material includes the ceramic coating layer, resistance to thickness expansion is decreased, thereby improving the cycle life characteristic.

That is, the performance and safety of the battery as well as the processability of the battery may be improved by using the electrode active material according to the exemplary embodiment of the present invention, and the electrochemical characteristic may be improved by using the electrode active material on which the ceramic is uniformly coated.

The carbon-based active material may be natural graphite, artificial graphite, soft carbon, hard carbon, or a combination thereof, but is not limited thereto.

The low crystalline carbon material may be petroleum-based pitch, coal-based pitch, mesophase pitch, low molecular heavy oil, polyvinyl alcohol (PVA), polyvinyl chloride (PVC), sucrose, phenol resin, furan resin, furfuryl alcohol, polyacrylonitrile, cellulose, styrene, polyimide, epoxy resin, glucose, or a combination thereof, but is not limited thereto.

The ceramic may be an oxide generated from a metal oxide, a non-metal oxide, a composite metal oxide, a rare-earth oxide, a metal halide, a ceramic precursor, or a combination thereof.

The ceramic precursor may be zirconia, aluminum, polycarbosilane, polysiloxane, polysilazane, or combination thereof, but is not limited thereto.

For example, the ceramic may be SiO₂, Al₂O₃, Li₄Ti₅O₁₂, TiO₂, CeO₂, ZrO₂, BaTiO₃, Y₂O₃, MgO, CuO, ZnO, AlPO₄, AlF, Si₃N₄, AlN, TiN, WC, SiC, TiC, MoSi₂, Fe₂O₃, GeO₂, Li₂O, MnO, NiO, zeolite, or combination thereof, but is not limited thereto.

An average particle size of the carbon-based active material may be 5 to 30 μm, specifically, 10 to 25 μm.

When the average particle size of the carbon-based active material exists within the range, a stable anode slurry may be prepared at the time of preparing the electrode, thereby preparing a high-density electrode. In addition, in the battery prepared by the method, the cycle life characteristic and the safety of the battery may be particularly improved.

An average particle size of the ceramic may be 10 to 1000 nm, specifically, 10 to 100 nm.

In the case in which the average particle size of the ceramic exists within the range, uniformity of the ceramic coating may be secured.

The electrode active material for the rechargeable lithium battery according to the exemplary embodiment of the present invention may be prepared by mixing the carbon-based active material of which the surface is subjected to coating with the low crystalline carbon material and the ceramic by using a mechanical mixing method.

Surface energy is generated by mechanical energy of the mechanical mixing method. As a result, the mechanical mixing method is used to perform the coating by adhering/fusing interfaces having high surface energy. For example, the mechanical mixing method may be performed by using any one method selected from a group consisting of ball milling, mechanofusion milling, shaker milling, planetary milling, attritor milling, disk milling, shape milling, nauta milling, nobilta milling, high speed mixing, or a combination thereof, but is not limited thereto.

The mechanical mixing method may be performed in between 500 to 7000 rpm.

The method for preparing the electrode active material for the rechargeable lithium battery according to the exemplary embodiment of the present invention may further include a heat treatment process in addition to the mechanical mixing method.

A content of the ceramic may be 0.1 to 10 parts by weight based on 100 parts by weight of the carbon-based active material where the surface is subjected to coating with the low crystalline carbon material. In detail, the content of the ceramic may be 0.5 to 3 parts by weight. When the content of the ceramic exists within the range, coagulation between the ceramic particles may be controlled, thereby making it possible to uniformly coat.

According to another preferred embodiment of the present invention, a rechargeable lithium battery including an electrode including the electrode active material and the electrolyte may be provided.

The electrode may include the cathode and the anode, and may have a separator disposed between the cathode and the anode.

The rechargeable lithium battery may be classified into lithium ion battery, a lithium ion polymer battery, and a lithium polymer battery according to a kind of the electrolyte and the separator used therein, it may have a cylindrical shape, a square shape, a coin shape, a pouch shape, or the like, and it may be a bulk type or a thin film type according to a size. Since the structure of the battery and the method for preparing the same are well known in the art, the detailed description thereof will be omitted.

The anode includes the current collector and an anode active material layer formed on the current collector, and the anode active material layer includes the anode active material.

The anode active material may be the above-mentioned electrode active material.

The anode active material layer also includes a binder, and may further optionally include conductive material.

The binder may serve to attach the anode active material particles to each other and attach the anode active material to the current collector. As a typical example, polyvinyl alcohol, carboxy methyl cellulose, hydroxypropyl cellulose, polyvinyl chloride, carboxylated polyvinyl chloride, polyvinylidene fluoride, a polymer containing ethylene oxide, polyvinyl pyrrolidone, polyurethane, polytetrafluoroethylene, polyvinylidene fluoride, polyethylene, polypropylene, polyamide, polyamide imide, styrene-butadiene rubber, acrylated styrene-butadiene rubber, epoxy resin, nylon, or the like may be used, but is not limited thereto.

The conductive material is used in order to give conductivity to the electrode, and may be any material as long as the electronic conductive material does not trigger a chemical change in the battery configured according to the method. For example, a conductive material may contain a carbon-based material such as natural graphite, artificial graphite, carbon black, acetylene black, ketjen black, carbon fiber, or the like; a metal powder such as copper, nickel, aluminum, silver, or the like; or mixture thereof.

As the current collector, a copper thin film, a nickel thin film, a stainless steel thin film, a titanium thin film, a nickel foam, a copper foam, a polymer basic material coated with a conductive metal, or a combination thereof may be used.

The cathode includes the current collector and the cathode active material layer formed on the current collector.

As the cathode active material, a compound (lithiated intercalation compound) capable of reversibly intercalating and deintercalating lithium ions may be used. In detail, the cathode active material may be at least one composite oxide formed of a metal such as cobalt, manganese, nickel, aluminum, iron, magnesium, vanadium, or a combination thereof and the lithium, and for example, the above-mentioned electrode active material may be used.

The cathode active material layer includes the binder and the conductive material.

The binder may serve to attach the anode active material particles to each other and attach the anode active material to the current collector. As a typical example, polyvinyl alcohol, carboxy methyl cellulose, hydroxypropyl cellulose, diacetylcellulose, polyvinyl chloride, carboxylated polyvinyl chloride, polyvinylidene fluoride, a polymer containing ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, nylon, or the like may be used, but is not limited thereto.

The conductive material is used in order to give conductivity to the electrode, and may be any material as long as the electronic conductive material does not trigger a chemical change in the battery configured according to the method. For example, the metal powder, the metal fiber, or the like such as natural graphite, artificial graphite, carbon black, acetylene black, ketjen black, carbon fiber, copper, nickel, aluminum, silver, or the like may be used. In addition, a mixture of one or more conductive materials such as polyphenylene derivatives or the like may be used.

As the current collector, the aluminum (AL) may be used, but the current collector is not limited thereto.

The active material composition is prepared by mixing the active material, the conductive material, and the binding agent with a solvent, and each of the anode and the cathode is prepared by applying the composition to the current collector. The method for preparing the electrode as described above is well-known to those skilled in the art. Therefore, a detailed description thereof in the specification will be omitted. As the solvent, N-methylpyrrolidone, distilled water, or the like may be used, but the solvent is not limited thereto.

The electrolyte may include a non-aqueous organic solvent and a lithium salt.

The non-aqueous organic solvent serves as a medium capable of moving the ions concerned in the electrochemical reaction of the battery.

As the non-aqueous organic solvent, a carbonate, an ether, an ether, a ketone, an alcohol, or an aprotic solvent may be used.

The non-aqueous organic solvent may be use alone or in a combination of one or more solvents, and a mixing ratio of the solvent in the case in which the mixture of the one or more solvents is used may be appropriately adjusted according to the desired battery performance. The configuration will be widely understood by those skilled in the art.

The lithium salt dissolves in the non-aqueous organic solvent, so it is possible to operate the basic rechargeable lithium battery by it applying as the lithium ion source within the battery. The lithium salt serves to promote the movement of the lithium ions between the cathode and the anode. The lithium salt may include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (herein, x and y are natural numbers), LiCl, LiI, LiB(C₂O₄)₂ (lithium bis(oxalato) borate; LiBOB), or combination thereof, as a supporting electrolytic salt.

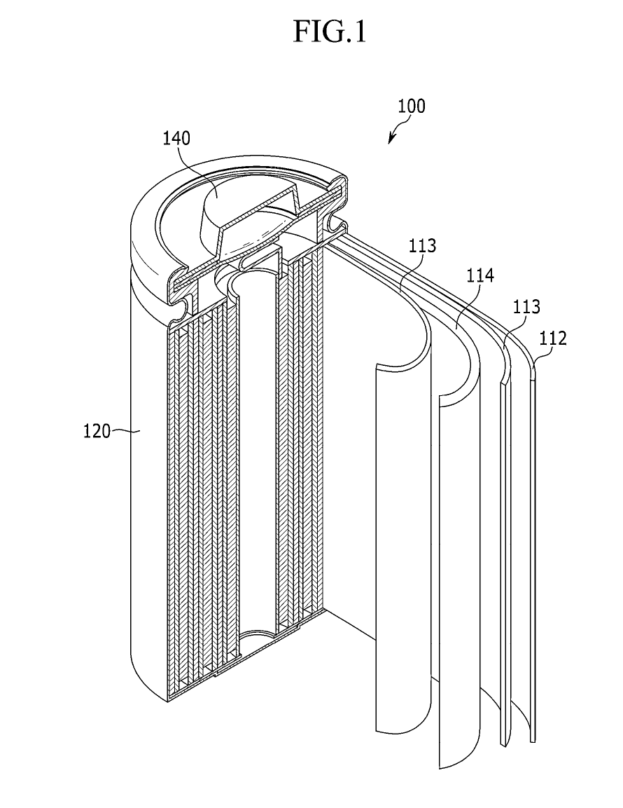

Referring to FIG. 1, the separator 113 serves to electrically isolate the anode 112 and the cathode 114 from each other and provide a moving path for the lithium ions. Any separator may be used as long as it is generally used in a lithium secondary battery. That is, a separator having excellent wetting performance while having low resistance to ion movement of the electrolyte may be used. For example, the separator may be any one selected from a glass fiber, Teflon, polyethylene, polypropylene, polytetrafluoroethylene (PTFE), and combinations thereof, and may also be a non-woven or woven fabric type. For example, a polyolefin polymer separator such as polyethylene, polypropylene, or the like is mainly used in the lithium ion battery. Further, a separator coated with a ceramic component or a polymer material in order to secure mechanical strength or heat resistance may be optionally used in a single-layer or multi-layer structure.

Hereinafter, examples and comparative examples of the present invention will be described. However, this is only one example of the present invention and the present invention is not limited thereto.

### Example 1

### Preparation of Anode Active Material Composition for a Rechargeable Lithium Battery

Natural graphite coated with a low crystalline carbon material (an average particle size (D₅₀): 16 μm) (PAS-CP3, Posco Chemtech) and a SiO₂ ceramic (an average particle size (D₅₀): 10 nm) are mixed at a weight ratio of 100:1.5, and by using a mechanical mixing method at 2000 rpm for 20 minutes in a high-speed agitator, an anode active material on which the ceramic is coated is prepared.

### (Preparation of Anode)

The prepared anode active material, styrene-butadiene rubber (SBR) as a binder, and carboxymethyl cellulose (CMC) as a thickener are mixed at a mass ratio of 97:1.5:1.5, and then dispersed in distilled water with ions removed to prepare the anode active material layer composition.

The composition is coated and dried on a cu-foil current collector, followed by pressing to thereby prepare an anode having electrode density of 1.50±0.05 g/cm³.

### (Preparation of a Rechargeable Lithium Battery)

The anode is used as operation electrode and the metal lithium is used as a counter electrode to prepare a half-cell battery (2032-type coin cell). In this case, a separator made of a porous polypropylene film is inserted between the working electrode and the counter electrode, and an electrolyte solution in which LiPF₆ at a 1 M concentration is dissolved in a mixed solution of diethyl carbonate (DEC) and ethylene carbonate (EC) at a mixing volume ratio of 7:3 are used.

### Example 2

An anode active material and an anode are prepared by the same method as in Example 1, except that Al₂O₃ instead of SiO₂ is used to prepare a rechargeable lithium battery.

### Example 3

An anode active material and an electrode are prepared by the same method as in Example 1, except that TiO₂ instead of SiO₂ is used to prepare a rechargeable lithium battery.

### Example 4

Natural graphite coated with a low crystalline carbon material (an average particle size (D₅₀): 16 μm)(PAS-CP3, Posco Chemtech) and TiO₂ ceramic (an average particle size (D₅₀): 50 nm) are mixed at a weight ratio of 100:3.0, and by using a mechanical mixing method at 2000 rpm for 20 minutes in high-speed agitator, an anode active material on which ceramic is coated is prepared.

An anode is prepared by the same method as in Example 1, except that the anode active material composition is used to prepare a rechargeable lithium battery.

### Comparative Example 1

Natural graphite having an average particle size (D₅₀) of 16 μm and a petroleum based pitch are mixed at a weight ratio of 100:4.5 using a mechanical mixing method at 2200 rpm for 10 minutes in a high-speed agitator to prepare a uniform mixture.

A heat treatment is performed on the sample at 1100° C. for 5 hours under a nitrogen atmosphere by injecting the uniform mixture into a vessel and is classified as 45 μm to thereby prepare an anode active material composition containing spherical natural graphite coated with the carbon precursor.

An electrode is prepared by the same method as in Example 1 except that it uses the anode active material composition to prepare a rechargeable lithium battery.

### Evaluation 1: Scanning Electron Microscope (SEM) Photograph

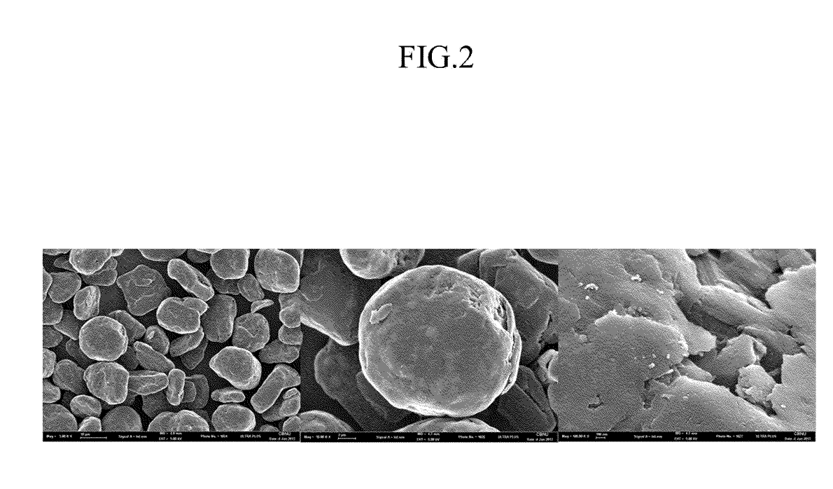

FIG. 2 is a scanning electron microscope (SEM) photograph showing a surface state of an anode active material according to an exemplary embodiment of the present invention.

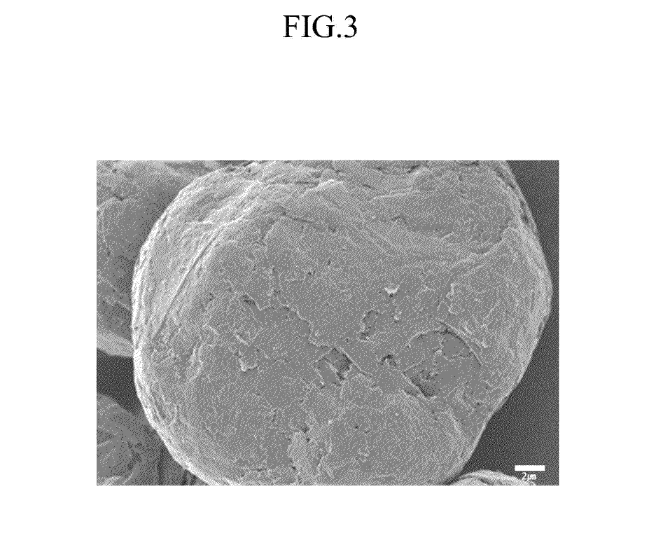

FIG. 3 is a scanning electron microscope (SEM) photograph showing a surface state of an anode active material according to Comparative Example 1.

Referring to FIGS. 2 and 3, it can be confirmed that the ceramic is uniformly coated in the case of the anode active material according to the exemplary embodiment compared to Comparative Example 1.

### Evaluation 2: Evaluation of a Thickness Expansion Characteristic of a Rechargeable Lithium Battery

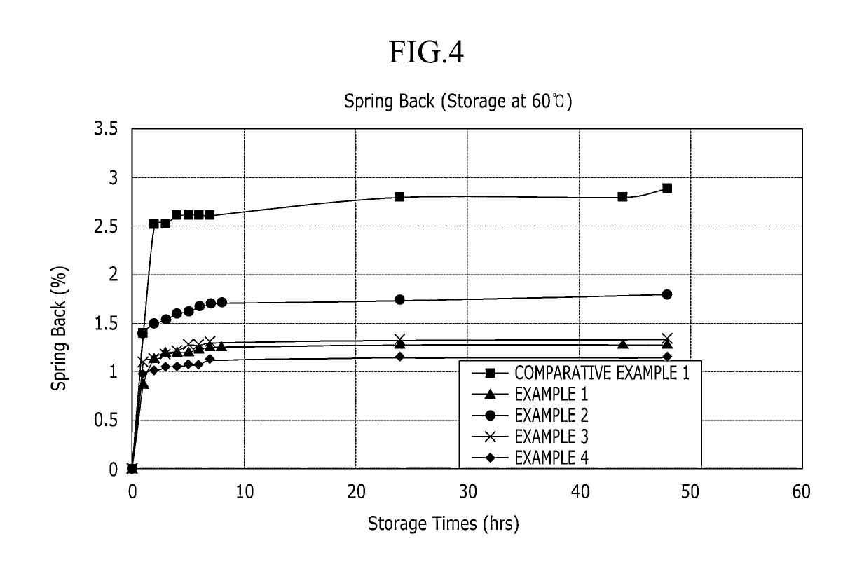

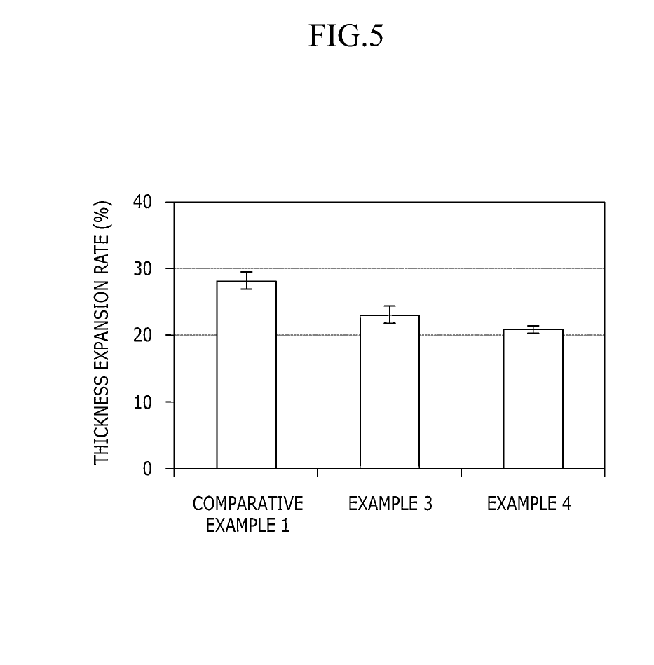

Evaluation 2 evaluates the thickness expansion characteristic of a rechargeable lithium battery prepared according to Examples 1 to 4 and Comparative Example 1, and the results are shown in Table 1 and FIGS. 4 and 5.

2-1. Evaluation of Spring Back

The anode active material composition prepared according to Examples 1 to 4 and Comparative Example 1 is dried and ground to a power, and is then classified using a classification network to a size of 75 μm to prepare pellets having a density of 1.5 g/cc. At the time of preparing the pellet, initial thickness and thickness after 48 hours are measured, respectively, and then spring back is evaluated by the following Equation 1.

Spring back(%)=(Expansion thickness)/(Initial thickness)*100 [Equation 1]

### 2-2. Evaluation of Swelling

The anode active material prepared according to Examples 3 and 4 and Comparative Example 1 are used as operation electrodes to prepare half-cell batteries (2032-type coin cell). The half-cell batteries are charged and discharged three times at 0.1 C and again charged, thereby evaluating the battery when the charging of the battery is completed. First, cleaning is performed using diethyl carbonate (DEC), a thickness of the charged anode electrode and the initial electrode is measured, respectively, and then swelling is evaluated by the following Equation 2.

Swelling(%)=(thickness of charged anode electrode-thickness of Cu foil)/(thickness of initial anode electrode-thickness of Cu foil)*100 [Equation 2]

FIG. 4 is a graph showing results of spring back for a rechargeable lithium battery evaluated at 60° C. according to an exemplary embodiment of the present invention.

FIG. 5 is a graph showing a degree of swelling of a rechargeable lithium battery according to an exemplary embodiment of the present invention.

Table

Referring to Table 1 and FIGS. 4 and 5, it may be confirmed that the anodes according to Examples 1 to 4 have a small change in thickness compared to the anode according to Comparative Example 1.

That is, in the case of applying the anode active material according to an exemplary embodiment of the present invention, a pouch cell may be easily designed and the cycle life characteristic of the battery at the time of charging and discharging may be improved.

TABLE 1

| | Spring back (%) | Swelling (%) |
|---|---|---|
| Example 1 | 1.3 | — |
| Example 2 | 1.9 | — |
| Example 3 | 1.3 | 24 |
| Example 4 | 1.1 | 21 |
| Comparative Example 1 | 2.9 | 28 |

### Evaluation 3: Evaluation of Impedance (Resistance) Characteristic of a Rechargeable Lithium Battery

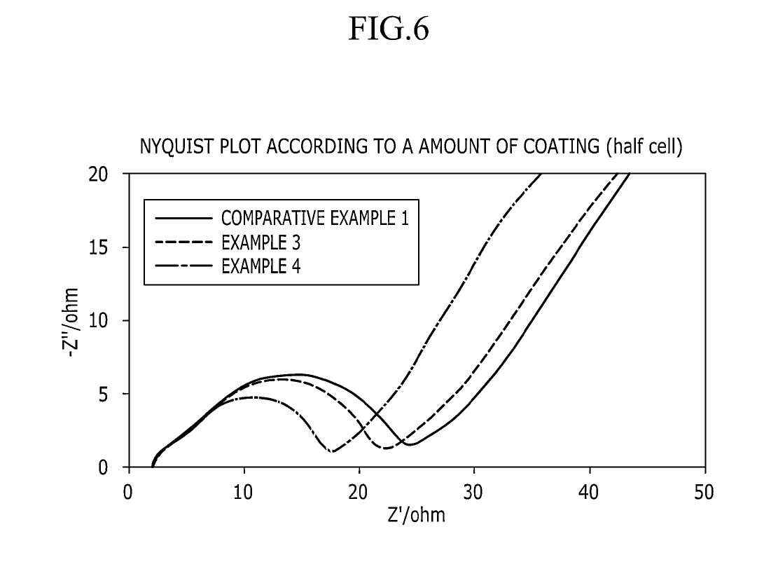

The impedance (resistance) characteristic of a rechargeable lithium battery prepared according to Examples 3 and 4 and Comparative Example 1 are evaluated, and the results are shown in FIG. 6.

The anode active material prepared according to Examples 3 and 4 and Comparative Example 1 is used as an operation electrode to prepare a half-cell battery (2032-type coin cell). The half-cell battery is charged and discharged three times at 0.1 C and is again charged, thereby evaluating the impedance (resistance) in a state in which the battery is charged 50%.

FIG. 6 is a graph showing impedance (resistance) of a rechargeable lithium battery according to an exemplary embodiment of the present invention.

Referring to FIG. 6, it may be confirmed that the resistance corresponding to the movement of the electrical charge in the half-cell battery according to Examples 3 and 4 has a small change in thickness is decreased compared to Comparative Example 1.

That is, in the case of applying the anode active material according to an exemplary embodiment of the present invention, the cycle life characteristic of the battery at the time of charging and discharging may be improved.

The present invention is not limited to the exemplary embodiments, but may be implemented in various different forms. It may be understood by those skilled in the art to which the present invention pertains that the present invention may be implemented with other specific forms without changing the spirit or essential features thereof. Therefore, it should be understood that the above-mentioned embodiments are not restrictive but are exemplary in all aspects.

<Description of Symbols>

| | |
|---|---|
| 100: rechargeable lithium battery | 112: anode |
| 113: separator | 114: cathode |
| 120: vessel | 140: sealing member |

What is claimed is:

1. An electrode active material for a rechargeable lithium battery, comprising:
a core part including a carbon-based active material; and
a coating layer disposed on a surface of the core portion to include a ceramic,
wherein the surface of the core part is subjected to coating with a low crystalline carbon material.

2. The electrode active material for the rechargeable lithium battery of claim 1, wherein the carbon-based active material is natural graphite, artificial graphite, soft carbon, hard carbon, or a combination thereof.

3. The electrode active material for the rechargeable lithium battery of claim 1, wherein the low crystalline carbon material is petroleum-based pitch, coal-based pitch, mesophase pitch, low molecular heavy oil, polyvinyl alcohol (PVA), polyvinyl chloride (PVC), sucrose, phenol resin, furan resin, furfuryl alcohol, polyacrylonitrile, cellulose, styrene, polyimide, epoxy resin, glucose, or a combination thereof.

4. The electrode active material for the rechargeable lithium battery of claim 1, wherein the ceramic is an oxide generated from a metal oxide, a non-metal oxide, a composite metal oxide, a rare-earth oxide, a metal halide, a ceramic precursor, or a combination thereof.

5. The electrode active material for the rechargeable lithium battery of claim 4, wherein: the ceramic precursor is zirconia, aluminum, polycarbosilane, polysiloxane, polysilazane, or a combination thereof.

6. The electrode active material for the rechargeable lithium battery of claim 1, wherein the ceramic is SiO₂, Al₂O₃, Li₄Ti₅O₁₂, TiO₂, CeO₂, ZrO₂, BaTiO₃, Y₂O₃, MgO, CuO, ZnO, AlPO₄, AlF, Si₃N₄, AlN, TiN, WC, SiC, TiC, MoSi₂, Fe₂O₃, GeO₂, Li₂O, MnO, NiO, zeolite, or a combination thereof.

7. The electrode active material for the rechargeable lithium battery of claim 1, wherein an average particle size of the carbon-based active material is 5 to 30 μm.

8. The electrode active material for the rechargeable lithium battery of claim 1, wherein: an average particle size of the ceramic is 10 to 1000 nm.

9. A method for preparing an electrode active material for a rechargeable lithium battery, comprising mixing a carbon-based active material of which the surface is subjected to coating with a low crystalline carbon material and a ceramic by using a mechanical mixing method.

10. The method of claim 9, wherein the mechanical mixing method is performed between 500 and 7000 rpm.

11. The method of claim 9, wherein a content of the ceramic is 0.1 to 10 parts by weight based on 100 parts by weight of the carbon-based active material, wherein the surface is subjected to coating with the low crystalline carbon material.

12. A rechargeable lithium battery comprising an electrode containing the electrode active material for the rechargeable lithium battery of any one of claim 1 to claim 8, and an electrolyte.
